(19) United States
(12) Patent Application Publication
(10) Pub. No.: US 2026/0065447 A1
(43) Pub. Date: Mar. 5, 2026

(54) SPATIAL AND MIXED REALITY CAPTURE WITH ENHANCED METADATA

(71) Applicant: APPLE INC., Cupertino, CA (US)

(72) Inventors: Xin Wang, Cupertino, CA (US); Hang Yin, San Jose, CA (US); Qing Song, Santa Clara, CA (US); Jin Wook Chang, San Jose, CA (US); Taoran Lu, Santa Clara, CA (US); Maneli Noorkami, Menlo Park, CA (US); Afshin Taghavi Nasrabadi, Los Gatos, CA (US); Mohammad Shafiei Rezvani Nezhad, Sunnyvale, CA (US); Renbo Cao, San Jose, CA (US); Henryk K. Blasinski, Mountain View, CA (US); Xuemei Zhang, Mountain View, CA (US); Yonghui Zhao, San Jose, CA (US); Hao Pan, Cupertino, CA (US); Munehiro Nakazato, San Jose, CA (US); Ying Xu, San Jose, CA (US)

(21) Appl. No.: 19/312,417

(22) Filed: Aug. 28, 2025

Related U.S. Application Data
(60) Provisional application No. 63/689,250, filed on Aug. 30, 2024.

(51) Int. Cl. G06T 5/90; G02B 27/01; G09G 3/20

(52) U.S. Cl. CPC G06T 5/90; G02B 27/0172; G09G 3/20; G09G 2320/0626

(57) ABSTRACT

Various implementations disclosed herein include devices, systems, and methods that incorporate enhanced metadata into spatial and/or mixed reality capture environments. For example, a process may include capturing an original video content recording that includes one or more frames depicting a first view provided by a head mounted device (HMD) at one or more instants in time. The process may further generate an adapted video content recording by adapting brightness of the one or more frames of the original video content recording to account for a difference between a first viewing condition associated with the first view and a second viewing condition associated with non-immersive viewing. The process may further generate metadata comprising information associated with the first viewing condition and the metadata may be associated with the adapted video content recording.

### TECHNICAL FIELD

The present disclosure generally relates to systems, methods, and devices that capture and replay content (e.g., stereoscopic videos) depicting spatial scenes and/or mixed reality experiences.

### BACKGROUND

Existing systems used to capture and replay content (e.g., stereoscopic videos) depicting spatial scenes and/or mixed reality experiences may be improved to provide more accurate, desirable, and/or enhanced content viewing experiences.

### SUMMARY

Various implementations disclosed herein include devices, systems, and methods that package metadata with recorded or streaming video content. Such metadata may be used, for example, to align or otherwise configure rendering attributes of the content for viewing via one or multiple viewing devices. For example, an original view of content (e.g., video content) presented on a head mounted device (HMD) may be recorded for playback or streamed-viewing on the HMD and/or other devices such as, inter alia, a high dynamic range (HDR) television display. In some implementations, the recorded view may be recorded in an adapted format and associated with metadata. For example, recording the view in an adapted format may include mastering original view frames with adjusted brightness attributes for viewing on non-immersive devices such as an HDR display. Likewise, the metadata may include information associated with a viewing condition of the original view that enables playback/streamed viewing and remastering on immersive devices such as an HMD (e.g., such that an HMD playback of content is provided and experienced in the same way as the HMD view was provided and experienced during capture). The adapted format may include brightness adjustments (e.g., adjustments to recorded or streaming video content) to account for dim lighting conditions in an original, immersive HMD viewing environment to provide a similar user experience in brighter viewing conditions associated with non-immersive/non-HMD devices (e.g., such that the content is presented differently on the non-immersive device than it was presented on the original device during capture but in a way that the user experience in viewing the content on the non-immersive device is similar to the original user experience on the original device during capture).

In some implementations, mastered video content may be packaged with metadata associated with the original viewing condition. For example, the metadata may include a user brightness adaptation measurement that is configured to determine a light intensity that a user's eyes are adapted to on an immersive device (e.g., an HMD) during recording. In some implementations, the metadata may enable the recording to be adaptively remastered and replayed on a same or another immersive device (e.g., HMD) with an original brightness to correspond to dim lighting conditions of an immersive (e.g., HMD viewing environment) to provide a similar viewing experience with respect to an original viewer's experience.

In some implementations, a view such as a video recording of pass-through content of an immersive device experience (e.g., an HMD experience) may be presented on a non-immersive device (e.g., a mobile device, a laptop, etc.). The video recording may include metadata associated with an original viewing condition (e.g., information corresponding to a user's chromatic adaptation state) enabling color adjusted playback or streamed-viewing on non-immersive devices. For example, during playback of the video recording on the non-immersive device, a color of the content may be adjusted to account for an original viewing condition based on the metadata. Likewise, during playback of the video recording on the non-immersive device, a playback viewing condition may be adjusted based on sensor data). In some implementations, a color may be adapted to account for expected differences in user chromatic adaptation state such that a color tone associated with non-immersive device viewing may appear to a user to match a color tone originally experienced on an immersive device (e.g., an HMD).

In some implementations, color adjustments may be implemented using data structures (e.g., 3×3 matrices) that enable color adjustments that correspond to differences in viewing conditions/chromatic adaptation states.

In some implementations, metadata may be associated with recorded image content from a multi-camera system. In some implementations, metadata may include statistical information associated with images obtained during image capture and processing via an image signal processing (ISP) pipeline. The statistical information may be used to enable rendering choices during playback of recorded image content and may include, inter alia, average, minimum, and maximum pixel values, an average brightness for HDR display, etc. Likewise, the statistical information may provide enhanced environmental awareness such as, for example, information corresponding to a wide field of view (e.g., observed by multiple cameras rather than a single camera) created from additional cameras such as left-facing cameras, right-facing cameras, side-facing cameras, downward-facing cameras, etc.

In some implementations, metadata may include data that corresponds to all cameras to provide information related to a surrounding (physical) environment. For example, a minimum pixel value for a total visual field of the left and right camera streams.

In some implementations, camera-specific metadata (including statistical information) may also be included such as, for example, a minimum pixel value for a left camera stream and minimum pixel value for a right camera stream.

In some implementations, metadata may include data corresponding to a select region of interest such that, for example, overlapping portions of a scene captured by two or more cameras are not overweighted with respect to enabling rendering choices. Likewise, double counting overlapping portions of images may be reduced during calculation of average pixel values for combined stereo frames (from multiple cameras with overlapping fields of view) by, for example, selecting an entire field of view (FOV) for one video stream and selecting a portion of the FOV that is not visible from the other camera. In some implementations, weighting of image statistics may be adjusted based on a user region of interest (ROI), for example, based on gaze.

In some implementations, left eye metadata and right eye metadata may be obtained during spatial capture from left and right eye camera pipelines. The left eye metadata and right eye metadata may each be associated with different characteristics such as, for example, differences with respect to camera components, sensors, processors (ISPs), streaming technologies, etc.

In some implementations, an HMD has a processor (e.g., one or more processors) that executes instructions stored in a non-transitory computer-readable medium to perform a method. The method performs one or more steps or processes. In some implementations, an original video content recording is captured. The original video content recording includes one or more frames depicting a first view provided by the HMD at one or more instants in time. In some implementations, an adapted video content recording is generated by adapting brightness of the one or more frames of the original video content recording to account for a difference between a first viewing condition associated with the first view and a second viewing condition associated with non-immersive viewing. In some implementations, metadata comprising information associated with the first viewing condition is generated and associated with the adapted video content recording.

In some implementations, a device has a processor (e.g., one or more processors) that executes instructions stored in a non-transitory computer-readable medium to perform a method. The method performs one or more steps or processes. In some implementations, a video content recording is obtained. The video content recording comprises one or more frames and is associated with metadata. The one or more frames depict a first view provided by a head-mounted device (HMD) at one or more instants in time. The first view comprises passthrough video of a first physical environment and the passthrough video is adapted for a first viewing condition on the HMD. The metadata comprises information associated with the first viewing condition. In some implementations, a second viewing condition is identified. The second viewing condition is associated with a second physical environment having a second viewing condition. The second view is presented in the second physical environment based on the video content recording. The second view is presented based on adjusting color of the one or more frames to account for the first viewing condition identified from the metadata and the second viewing condition.

In some implementations, a device has a first camera, a second camera, and a processor (e.g., one or more processors) that executes instructions stored in a non-transitory computer-readable medium to perform a method. The method performs one or more steps or processes. In some implementations, first video content and second video content are simultaneously captured and processed. The first video content corresponds to the first camera in a physical environment and the second video content corresponds to the second camera in the physical environment. In some implementations based on the capturing and processing of the first video content and second video content, statistical information corresponding to pixel values of the first video content and the second video content is generated. The statistical information corresponds to a total visual field of the first camera and second camera. In some implementations, the statistical information is associated as metadata with the first video content or second video content to facilitate rendering determinations during simultaneous playback of the first video content and second video content.

In some implementations, a device has a first camera, a second camera, and a processor (e.g., one or more processors) that executes instructions stored in a non-transitory computer-readable medium to perform a method. The method performs one or more steps or processes. In some implementations, first video content and second video content are simultaneously captured and processed. The first video content is captured via the first camera in a physical environment and the second video content is captured via the second camera in the physical environment. In some implementations based on the capturing and processing of the first video content and second video content, statistical information corresponding to regions of interest in the first video content and second video content is generated. The regions of interest may be identified based on identifying overlap in the first video content and second video content. The statistical information may be associated as metadata with the first video content or second video content to facilitate rendering determinations during simultaneous playback of the first video content and second video content.

In some implementations, a device has a first camera, a second camera, and a processor (e.g., one or more processors) that executes instructions stored in a non-transitory computer-readable medium to perform a method. The method performs one or more steps or processes. In some implementations, first video content and second video content are simultaneously captured and process. The first video content is captured via the first camera in a physical environment via a first video capture pipeline and the second video content is captured via the second camera in the physical environment via a second video content pipeline. In some implementations, first information corresponding a first pipeline-specific characteristic of the first video capture pipeline is generated. In some implementations, second information corresponding a second pipeline-specific characteristic of the second video capture pipeline is generated. In some implementations, the first information and second information are associated as metadata with the first video content or second video content to facilitate rendering determinations during simultaneous playback of the first video content and second video content.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRA WINGS

So that the present disclosure can be understood by those of ordinary skill in the art, a more detailed description may be had by reference to aspects of some illustrative implementations, some of which are shown in the accompanying drawings.

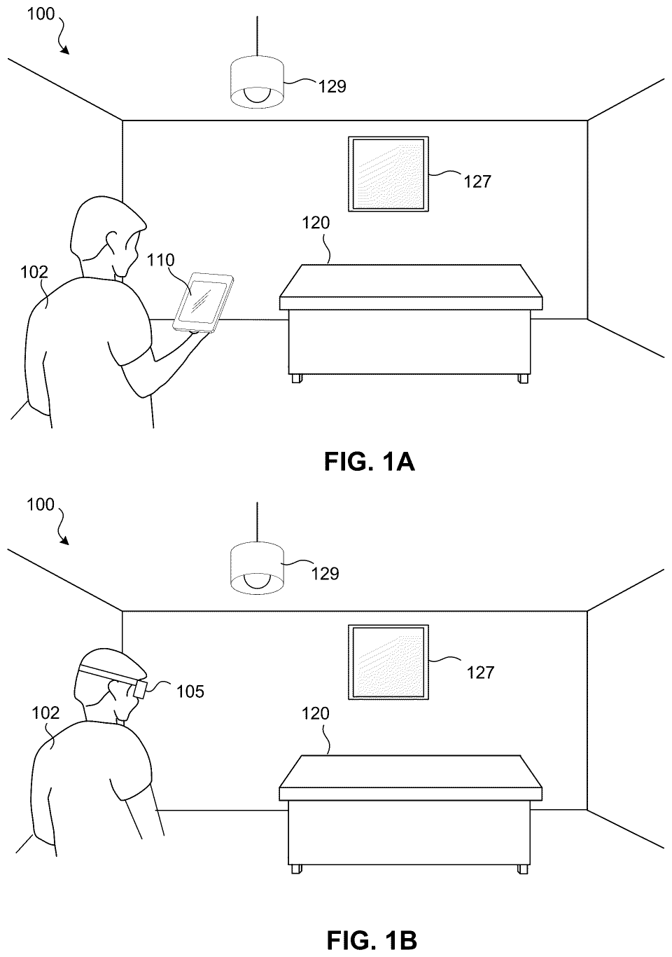

FIGS. 1A-1B illustrate exemplary electronic devices operating in physical environments, in accordance with some implementations.

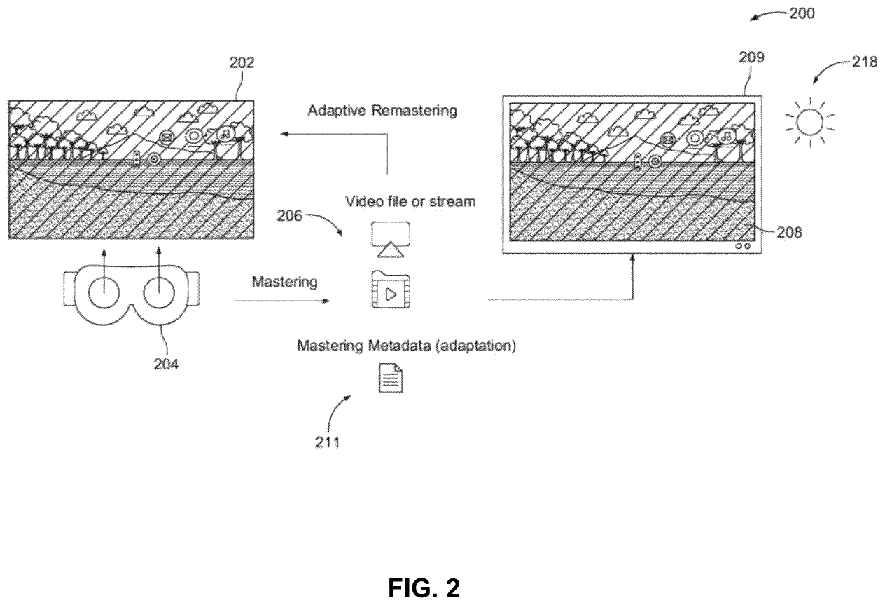

FIG. 2 illustrates an environment comprising a view of video content being presented via an HMD and video content presented via an external display in a different physical environment, in accordance with some implementations.

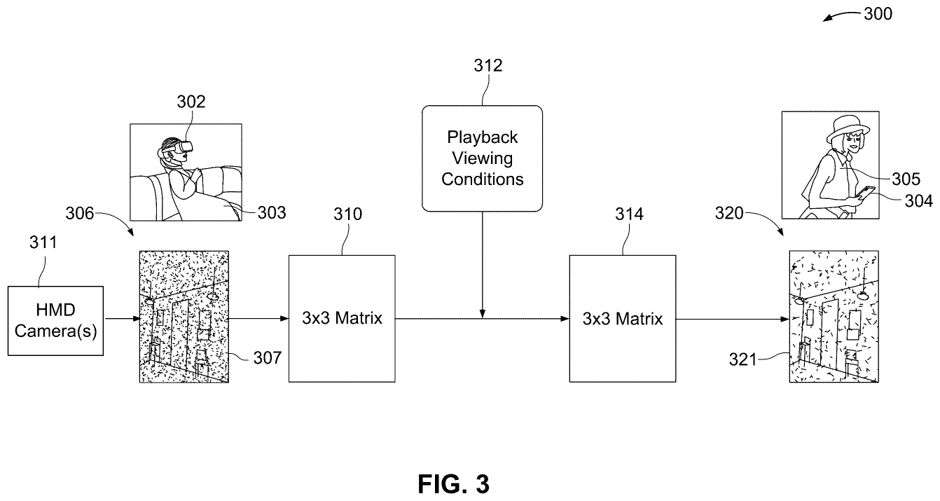

FIG. 3 illustrates a pipeline configured to present a view on a non-immersive device of an adapted video recording representing an immersive device experience as viewed by user of HMD, in accordance with some implementations.

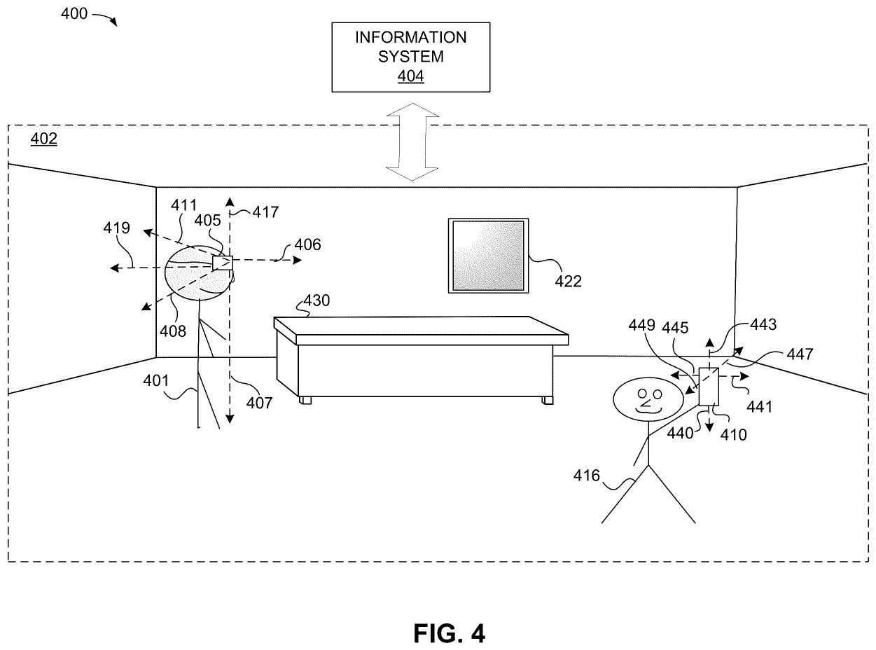

FIG. 4 illustrates an example of an environment that includes users each using a device to view content, in accordance with some implementations.

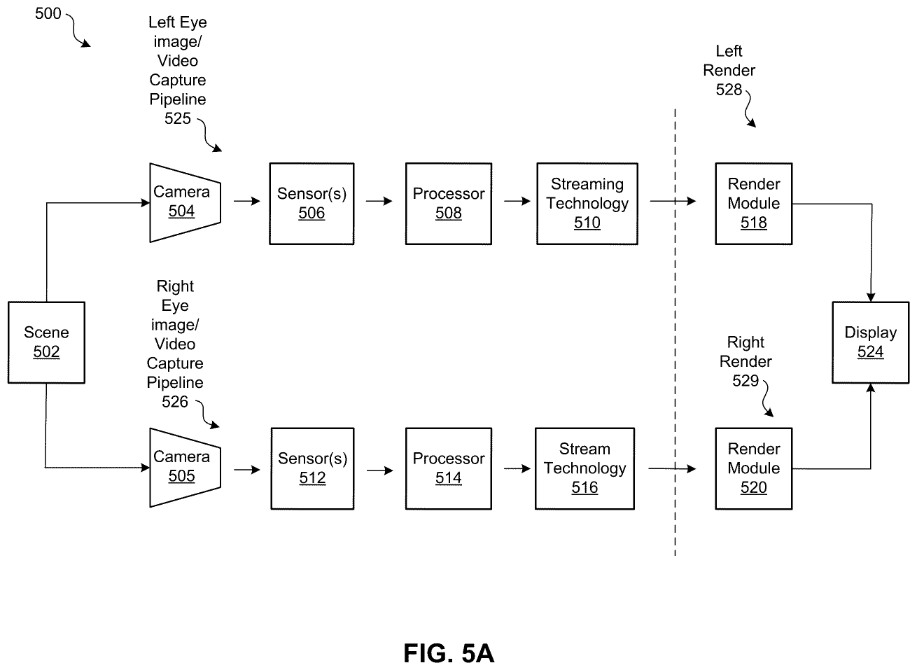

FIG. 5A illustrates a system comprising a left image capture pipeline and a right image capture pipeline, in accordance with some implementations.

FIG. 5B illustrates a frame rate conversion (FRC) process to generate new metadata for use in tone mapping processes, in accordance with some implementations.

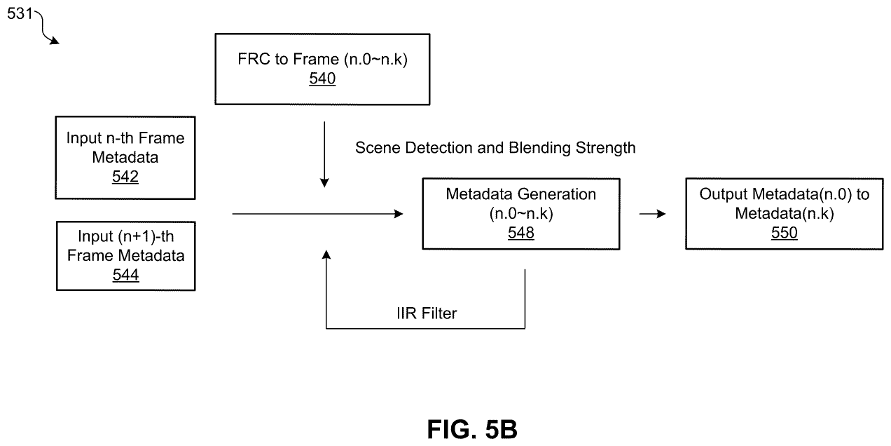

FIG. 6 is a flowchart representation of an exemplary method that records an original view of video content presented on an HMD for playback or streamed-viewing on a same or different devices, in accordance with some implementations.

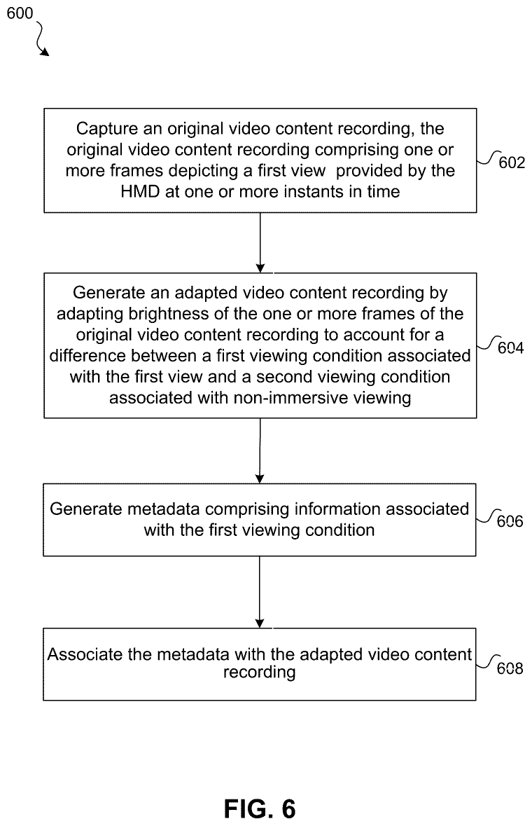

FIG. 7 is a flowchart representation of an exemplary method that presents a view on a non-immersive device of a video recording of an immersive device experience, in accordance with some implementations.

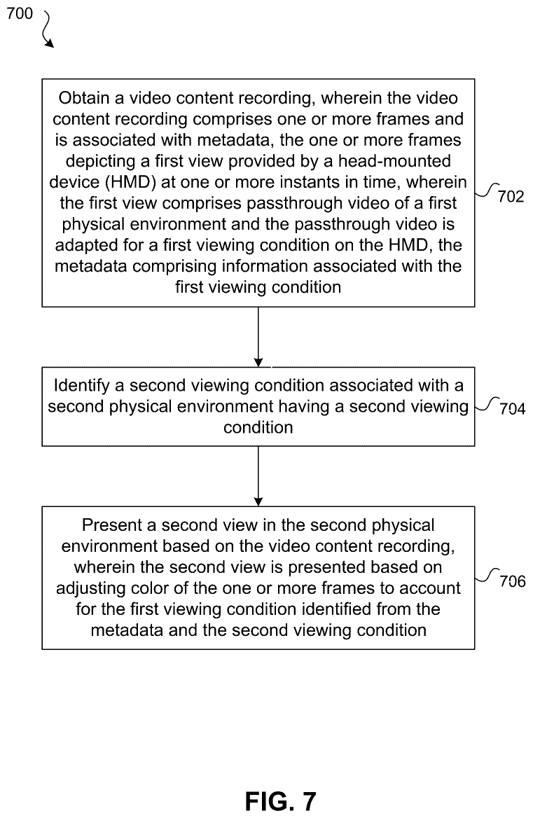

FIG. 8 is a flowchart representation of an exemplary method that associates metadata (associated with a surrounding environment) with recorded image content from a multi-camera system, in accordance with some implementations.

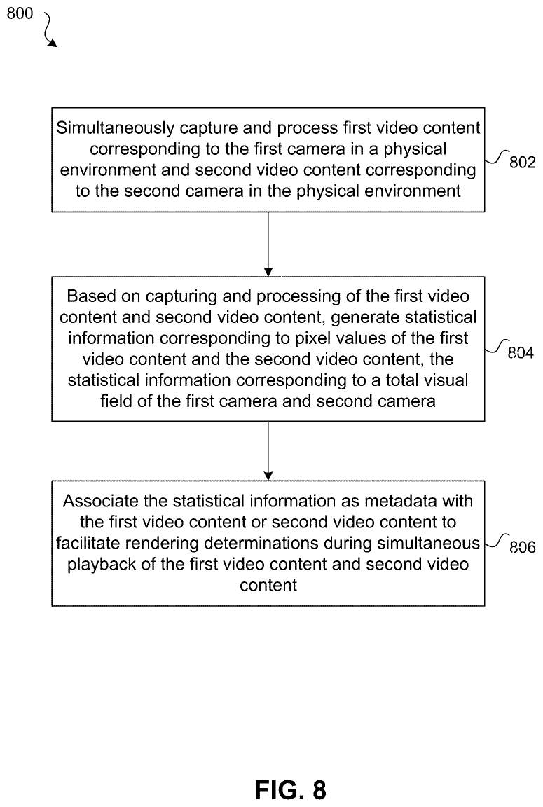

FIG. 9 is a flowchart representation of an exemplary method that associates metadata (associated with a region of interest (ROI)) with recorded image content from a multi-camera system, in accordance with some implementations.

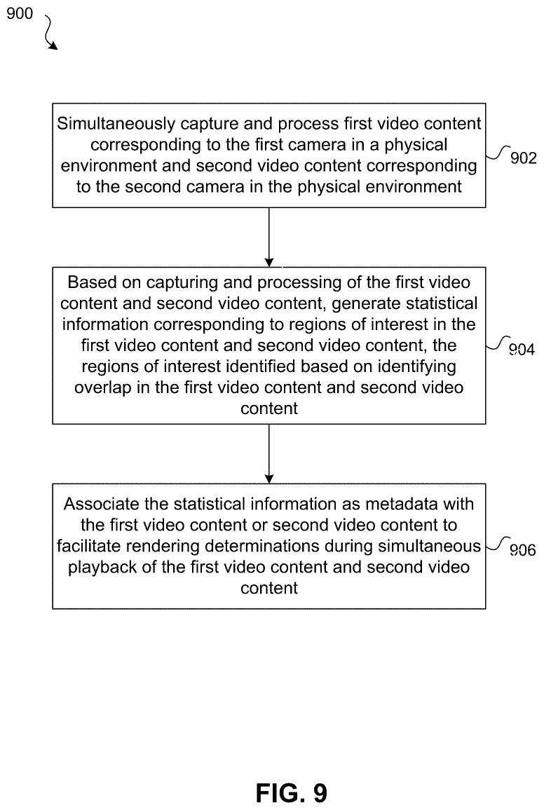

FIG. 10 is a flowchart representation of an exemplary method that collects left eye metadata and right eye metadata during spatial capture from left/right eye camera pipelines, in accordance with some implementations.

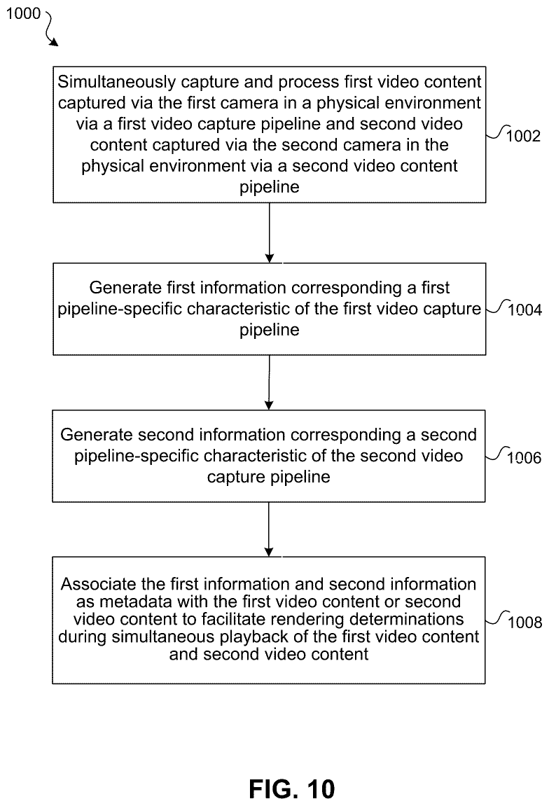

FIG. 11 is a block diagram of an electronic device, in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

FIGS. 1A-B illustrate exemplary electronic devices 105 and 110 operating in a physical environment 100. In the example of FIGS. 1A-B, the physical environment 100 is a room that includes a desk 120, a window 127, and a light 129. The electronic devices 105 and 110 may include one or more cameras, microphones, depth sensors, or other sensors that can be used to capture information about and evaluate the physical environment 100 and the objects within it, as well as information about the user 102 of electronic devices 105 and 110. The information about the physical environment 100 and/or user 102 may be used to provide visual and audio content and/or to identify the current location of the physical environment 100 and/or the location of the user within the physical environment 100.

In some implementations, views of an extended reality (XR) environment may be provided to one or more participants (e.g., user 102 and/or other participants not shown) via electronic devices 105 (e.g., a wearable device such as an HMD) and/or 110 (e.g., a handheld device such as a mobile device, a tablet computing device, a laptop computer, etc.). Such an XR environment may include views of a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system associated with the XR environment, which may correspond to a 3D coordinate system of the physical environment 100.

In some implementations, electronic device 105 and/or electronic device 110 may be configured to record an original view of, for example, video content presented on a wearable device such as, inter alia, an HMD for playback or streamed-viewing on a same device (e.g., device 105 or 110) or other devices such as an external non immersive device such as, inter alia, an HDR display, a laptop computer, a mobile device, a tablet, etc. For example, an original video content recording may be captured by a device such as an HMD. In some implementations, the original video content recording may include one or more frames depicting an original view provided by the HMD at one or more instants in time.

In some implementations, the original video content recording may be modified to generate an adapted video content recording by adapting brightness of the one or more frames of the original view of the original video content recording to account for a lighting or brightness difference between a first viewing condition associated with the original view and a second viewing condition associated with non-immersive viewing via a non-immersive display device. For example, the first lighting condition may include a dim lighting viewing condition provided via an immersive device such as HMD that may present the original view with little or no ambient lighting (e.g., sunlight from window 127 and/or lighting from light 129) due to a light seal on the HMD that prevents ambient light from the display environment. Likewise, the second viewing condition may include a bright lighting viewing condition associated with, for example, a television, a monitor, etc. being viewed in a physical environment (e.g., a room) that may include more ambient lighting such as sunlight provided via window 127, overhead lighting such as light 129, etc. In some implementations, metadata that includes information associated with the first viewing condition may be generated and associated with the adapted video content recording. For example, the metadata and the adapted video content recording may be stored within a same file and/or with respect to a streaming format.

In some implementations, a view of a video recording of an immersive device experience (e.g., a view of an HMD viewing experience) may be presented on a non-immersive device. For example, a video content recording such as a recording of a pass-through video-based HMD experience may be obtained. The video content recording may include one or more frames and associated metadata. In some implementations, the one or more frames may depict a first original view (e.g., an immersive view) of content provided by an HMD at one or more instants in time. The first original view may include passthrough video of a first physical environment and the passthrough video may be adapted for a first viewing condition on the HMD. The associated metadata may include information associated with the first viewing condition. For example, the first viewing condition may be based on the passthrough video being color adjusted with respect to the viewing environment being immersive (e.g., no-ambient light outside of the immersive view) and/or a lighting condition of the physical environment depicted in the first view. In some implementations, the metadata may be configured to identify a lighting condition such as warm, cool, etc. In some implementations, the metadata may include or be used to generate a 3 by 3 matrix used to implement a color tone shift. In some implementations, a second viewing condition associated with a second physical environment (e.g., another room) having a second viewing condition (e.g., a non-immersive viewing environment) may be identified. In some implementations, a second view in the second physical environment may be presented based on the video content recording such that a color of the one or more frames is adjusted to account for the first viewing condition identified from the metadata and the second viewing condition identified based on an assumption, sensor data, etc.

In some implementations, metadata that includes statistical information related to images obtained while the images are captured and processed through an ISP pipeline may be associated with recorded image content from a multi-camera system. For example, first video content corresponding to a first camera in a physical environment and second video content corresponding to the second camera in the physical environment may be simultaneously captured and processed and in response, related statistical information may be generated.

In some implementations, statistical information may correspond to pixel values of the first video content and the second video content with respect to a total visual field of the first camera and second camera. In some implementations, the statistical information may correspond to regions of interest (ROI) in the first video content and second video content. The regions of interest may be identified based on identifying overlap in the first video content and second video content.

In some implementations, the statistical information (corresponding to the aforementioned pixel values and/or ROI) may be associated as metadata with the first video content or second video content to facilitate rendering determinations during simultaneous playback of the first video content and second video content.

In some implementations, left eye metadata may be collected during spatial capture from a left eye camera pipeline and right eye metadata may be collected during spatial capture from a right eye camera pipeline. The left eye camera pipeline may include differing camera components, sensors, processors (ISPs), and/or streaming technologies, etc. from the right eye camera pipeline.

FIG. 2 illustrates an environment 200 comprising a view of video content 202 being presented via an HMD 204 and video content 208 (e.g., a recorded or streamed version 206 of video content being 202) presented via an external display 209 in a different physical environment, in accordance with some implementations. In some implementations, a user may view a dim environment (e.g., video content 202) via HMD 204 as a light seal (i.e., a structure that creates a tight fit between the HMD and a face of the user) of the HMD 204 is configured to reduce ambient light within a viewing environment of the HMD 204 thereby enabling eyes of the user to become adapted to the dim environment. Likewise, external display 209 may be located within a different, brighter environment (e.g., a physical environment comprising ambient light such as sunlight 218) that may be associated with a different dynamic range and brightness with respect to the viewing environment of the HMD 204. Therefore, if a recording or stream 206 comprising video content 202 (that has been presented via HMD 204) is presented to a user via external display 209, the user may be unable to view some details (e.g., objects) of the dim video content 202. Accordingly, an original view of video content 202 presented via HMD 204 may be recorded and adapted for playback or streamed-viewing via HMD 204 and/or external display 209. For example, a view of video content 202 may be recorded with respect to an adapted format (e.g., video content 208) such that original view frames of video content 202 are mastered with an adjusted brightness for viewing via external display 209 (e.g., a non-immersive device). Likewise, video content 202 recorded with respect to the adapted format may be associated with metadata 211 that includes original viewing condition information that enables original conditions for playback or streamed viewing via HMD 204 (e.g., an immersive device). For example, the adapted format may include mastering video content 202 with a brightness adjustment (to the video content 202) configured to account for the dim (or alternatively bright) lighting conditions of original video content 202 viewed via an immersive HMD viewing environment so that a similar user viewing experience (e.g., with respect to brightness) may be provided during brighter viewing conditions associated with external display 209 (e.g., within a bright physical environment) viewing. Therefore, the mastered video content may be packaged with metadata 211 associated with the original viewing condition (e.g., a user brightness adaptation measurement that may determine a light intensity that the users' eyes are adapted (e.g., eye adaptation state) to on the HMD 204 during recording in a dim or bright environment). The metadata 211 is configured to enable the recording or stream 206 to be adaptively remastered and replayed via HMD 204 or external display 209 such that a brightness level may be set back to correspond to dim (or differing bright) lighting conditions of an immersive viewing environment of HMD 204 to provide an experience that is similar to the original viewer's experience.

FIG. 3 illustrates a pipeline 300 configured to present a view 320 on a non-immersive device 304 of an adapted video recording 321 representing an immersive device experience 306 as viewed by user 303 of HMD 302, in accordance with some implementations. For example, adapted video recording 321 may be associated with an original video recording 307 of a pass-through video-based HMD experience created via an HMD camera(s) 311 (e.g., outward facing cameras) of HMD 302. In some implementations, original video recording 307 may be packaged with metadata 310 associated with an original viewing condition (e.g., of original video recording 307). The metadata 310 is configured to enable color adjusted playback and/or streamed-viewing (e.g., playback viewing conditions 312) representing an immersive device experience 306 on non-immersive device 304. The metadata 310 may include information corresponding to a chromatic adaptation state of a user 303 of HMD 302.

In some implementations, during playback of view 320 of adapted video recording 321 on the non-immersive device 304, a color of the content is adjusted to account for an original viewing condition associated with original video recording 307 (i.e., known from the metadata) and a playback viewing condition. The original viewing condition is determined via 310 metadata and the playback viewing condition may be determined from sensor data (e.g., associated with lighting conditions).

In some implementations, a color of original video recording 307 may be adapted to account for expected differences in user chromatic adaptation state. For example, a color tone associated with non-immersive device 304 viewing may be adjusted to appear to user 305 to match a color tone originally experienced by user 303 of HMD 302.

In some implementations, color adjustments may be implemented using data structures (comprised by metadata 310) such as 3×3 matrices that enable color adjustments corresponding to differences in viewing conditions and/or chromatic adaptation states. For example, a 3×3 matrix (comprised by metadata 310) may include a chromatic adaptation state of a user 303 of HMD 302 associated with content of original video recording 307. Subsequently, information determined by the play backing viewing condition associated with a chromatic adaptation of a user 305 of non-immersive device 304 may be used to determine a color correction change with respect to information of metadata 310 thereby adapting the 3×3 matrix of metadata 310 to form an updated 3×3 matrix comprising a color correction change as metadata 314 for converting from original video recording 307 associated with an original viewing condition to adapted video recording 321 representing an immersive device experience 306 for playback via non-immersive device 304.

FIG. 4 illustrates an example of an environment 400 that includes users each using a device to view content, in accordance with some implementations. For example, environment 400 illustrates: a user 401 wearing/operating a wearable (immersive device) device 405 in a physical environment 402 and a user 416 operating a non-immersive device 410 in physical environment 402.

In the example of FIG. 4, the physical environment 402 is a room that includes physical objects such as a desk 430 and a window 422. In some implementations, each electronic device 405 and 416 may include one or more cameras, microphones, depth sensors, motion sensors, optical sensors or other sensors that can be used to capture information about and evaluate the physical environment 102 and the objects within it, as well as information about user 110. Additionally, environment 400 includes an information system 404 (e.g., a device control framework or network) in communication with one or more of the electronic devices 405 and 416. In an exemplary implementation, electronic devices 405 and 416 are communicating, e.g., while the electronic devices 405 and 416 are sharing information with one another or an intermediary device such as a communication session server within the information system 404. In some implementations, electronic device 405 comprises an immersive wearable device (e.g., a head mounted display (HMD)) configured to present views of an extended reality (XR) environment, which may be based on the physical environment 402, and/or include added content such as virtual elements. In some implementations, electronic device 416 comprises a non-immersive device (e.g., a mobile device, a tablet, a computer, etc.) configured to present views of an extended reality (XR) environment, which may be based on the physical environment 402, and/or include added content such as virtual elements.

In some implementations, some statistical information associated with images (e.g., frames of a video file) may be collected during image capture (e.g., via electronic device 405 and/or electronic device 410) and processing via an image signal processing (ISP) pipeline. Statistical information may include, inter alia, average, minimum, and maximum pixel values, an average brightness for HDR display, etc. which may be saved in or with a video file as metadata and used, for example, during playback (of the video file) for an improved visual experience.

In some implementations, each of electronic devices 405 and 410 comprises multiple cameras. In some implementations, metadata comprising the aforementioned statistical information may be associated with recorded image content from multiple cameras of electronic device 405 and/or electronic device 410. The metadata including the statistical information associated with the images may be used to enable rendering selections during image playback. Likewise, the statistical information may provide enhanced environmental awareness such as, for example, information corresponding to a wide field of view (e.g., observed by all cameras of electronic device 405 or electronic device 416 rather than a single camera) created from multiple cameras such as left-facing, right-facing, side-facing, downward-facing, upward facing, front facing, rear facing cameras, etc. For example, statistical information corresponding to a wide field of view, observed by all cameras of electronic device 405 may include information from cameras (of electronic device 405) facing a front direction 406, an upward direction 417, a downward direction 407, a right facing direction 411, a left facing direction 408, and/or a rear facing direction 419. Likewise, statistical information corresponding to a wide field of view, observed by all cameras of electronic device 410 may include information from cameras (of electronic device 416) facing a front direction 447, an upward direction 443, a downward direction 440, a right facing direction 441, a left facing direction 445, and/or a rear facing direction 449.

In some implementations, the metadata may include all statistical data that corresponds to all cameras of electronic device 405 and/or electronic device 416 (e.g., a minimum pixel value for a total visual field of left and right camera streams) to provide information regarding the surrounding environment (e.g., physical environment 402). Likewise, camera-specific metadata comprising statistical information may be included (e.g., a minimum pixel value for a left stream and a minimum pixel value for a right stream) to provide information regarding the surrounding environment.

In some implementations, the metadata may include data corresponding to a select region of interest (ROI) so that, for example, overlapping portions of a scene captured by two or more cameras are not overweighted when selecting rendering choices. Likewise, double counting overlapping portions of images may be reduced during calculation of average pixel values for combined stereo frames (from multiple cameras with overlapping fields of view) by, for example, selecting an entire field of view (FOV) from multiple cameras for one video stream and selecting a portion of the FOV (e.g., from one camera) that is not visible from the other camera(s). In some implementations, a weighting of the statistical information may be adjusted based on a user ROI determined based on, for example, based on gaze. In some implementations, the metadata may include information related to a gaze position at capture time. Likewise, the metadata may include information related to aggregate statistics related to gaze such as, inter alia, an amount of motion, whether the eye was fixated or a saccade was detected etc. that may be collected with a single camera stream (e.g., looking at an eyeball) and may be attached to different streams.

FIG. 5A illustrates a system 500 comprising a left image capture pipeline 525 and a right image capture pipeline 526, in accordance with some implementations. Left image capture pipeline 525 and right image capture pipeline 526 are independently configured to collect independent left eye metadata and right eye metadata to account for differences in FOV, left and right eye cameras, and displays. For example, system 500 is configured to collects left eye metadata and right eye metadata during spatial capture processes from left image capture pipeline 525 and right image capture pipeline 526 each having different characteristics, such as differences in camera components, different sensors, different processors (ISPs), and/or different streaming technologies.

For example, left eye image/video content and right eye image/video content of a scene 502 may be simultaneously captured and processed such that the left eye image/video content is captured via a (left eye) camera 504 (e.g., a wide angle camera) in a physical environment via a left eye image/video capture pipeline 525 and the right eye image/video content is captured via a differing (right eye) camera (e.g., an ultra-wide angle camera) in the physical environment via the right eye image/video capture pipeline 526. Likewise, the left eye image/video content and right eye image/video content may be simultaneously processed such that the left eye image/video content is processed via sensors 506 and a processor 508 (ISP) and with respect to a first streaming technology type 510 via left eye image/video capture pipeline 525 and the right eye image/video content is processed via differing sensors 512 and a differing processor 514 (ZSP) and with respect to a second differing streaming technology type 516 via right eye image/video capture pipeline 526. Subsequently, first information corresponding a first pipeline-specific characteristic of the left eye image/video capture pipeline 525 is generated and second information corresponding to a second pipeline-specific characteristic of the right eye image/video capture pipeline 526.

In some implementations, the first information and the second information may be associated as metadata with the left eye image/video content and right eye image/video content to facilitate rendering determinations (via render modules 518 and 520) during simultaneous playback of the left eye image/video content and right eye image/video content via display 524.

FIG. 5B illustrates a frame rate conversion (FRC) process 531 configured to apply analysis techniques to frame content of a scene to generate new metadata that may be stored with respect to a frame-by-frame basis for use in tone mapping processes, in accordance with some implementations. For example, scene detection information and blending strength information resulting from FRC process 531 may be used to generate the new metadata. In some implementations, FRC process 531 may be applicable to mono scene/image captures. In some implementations, FRC process 531 may be applicable to stereo scene/image captures.

In some implementations, a source video file may be upconverted from, for example, 30 Hertz to 90 Hertz such that video frames are input at 30 Hertz and FRC process 531 converts the video frames to 90 Hertz resulting in 2 additional frames. Therefore, each of the original frames plus a next two frames generated (e.g., the 2 additional frames) may include metadata that is unique to each specific frame. The metadata may include information from FRC process 531 process that is associated with scene changes and frame static information which may affect a strength of a blending factor thereby resulting in output of frame specific metadata that may be used for generating a tone curve.

In some implementations, n-th Frame Metadata of block 542 (captured from a camera) and (n+1)-th Frame Metadata of block 544 may be input or added to Metadata Generation (n.0˜n.k) process of block 548 (e.g., determined during capture) to generate new metadata. Subsequently, Metadata Generation (n.0˜n.k) process of block 548 may be modified via FRC added frames (FRC to Frame (n.0˜n.k) of block 540) with respect to scene detection and blending strength data to generate as an output new metadata (Metadata(n.0) to Metadata(n.k) of block 550). Likewise, metadata for a next frame (Input(n+1)-th Frame Metadata of block 544) may be used (with respect to an IIR filter) for a next iteration of the process.

FIG. 6 is a flowchart representation of an exemplary method 600 that records an original view of video content presented on an HMD for playback or streamed-viewing on a same or different devices, in accordance with some implementations. In some implementations, the method 600 is performed by a device, such as a mobile device, desktop, laptop, HMD, or server device (e.g., device 110 of FIG. 1). In some implementations, the device has a screen for displaying images and/or a screen for viewing stereoscopic images such as a head-mounted display (HMD such as e.g., device 105 of FIG. 1). In some implementations, the method 600 is performed by processing logic, including hardware, firmware, software, or a combination thereof. In some implementations, the method 600 is performed by a processor executing code stored in a non-transitory computer-readable medium (e.g., a memory). Each of the blocks in the method 600 may be enabled and executed in any order.

At block 602, the method 600 captures an original video content recording that includes one or more frames depicting a first view provided by an HMD at one or more instants in time.

At block 604, the method 600 generates an adapted video content recording by adapting brightness of the one or more frames of the original video content recording to account for a difference between a first viewing condition associated with the first view and a second viewing condition associated with non-immersive viewing. For example, an adapted format of video content 208 such that original view frames of video content 202 are mastered with an adjusted brightness for viewing via external display 209 as described with respect to FIG. 2.

In some implementations, the first viewing condition comprises a dim lighting viewing condition provided by the HMD with a minimal amount of ambient lighting.

In some implementations, the first viewing condition comprises a dim lighting viewing condition provided by the HMD with no ambient lighting.

In some implementations, the second viewing condition comprises a bright lighting viewing condition viewed in a physical environment with ambient lighting.

At block 606, the method 600 generates metadata (e.g., metadata 211 of FIG. 2) comprising information associated with the first viewing condition. In some implementations, the information may associated with the first viewing condition may include a brightness adaptation measurement configured to determine a light intensity associated with eyes of a user with respect to viewing conditions of the HMD during the capturing.

At block 608, the method 600 associates the metadata with the adapted video content recording. For example, the adapted video content recording may be packaged with metadata 211 as described with respect to FIG. 2.

In some implementations, playback operations may be enabled on a non-immersive device using the adapted video content recording.

In some implementations, the playback operations may provide a consistent user viewing experience in accordance with a brightness level associated with the first view.

In some implementations, playback operations may be enabled on the HMD by further adapting the adapted video content using the metadata.

In some implementations, the playback operations may provide a consistent user viewing experience with respect to a brightness level associated with the first view.

In some implementations, associating the metadata with the adapted video content recording may include storing the metadata with the adapted video content recording in a same file.

In some implementations, associating the metadata with the adapted video content recording may include storing the metadata with the adapted video content recording with respect to a same streaming format.

FIG. 7 is a flowchart representation of an exemplary method 700 that presents a view on a non-immersive device of a video recording of an immersive device experience, in accordance with some implementations. In some implementations, the method 700 is performed by a device, such as a mobile device, desktop, laptop, HMD, or server device (e.g., device 110 of FIG. 1). In some implementations, the device has a screen for displaying images and/or a screen for viewing stereoscopic images such as a head-mounted display (HMD such as e.g., device 105 of FIG. 1). In some implementations, the method 700 is performed by processing logic, including hardware, firmware, software, or a combination thereof. In some implementations, the method 700 is performed by a processor executing code stored in a non-transitory computer-readable medium (e.g., a memory). Each of the blocks in the method 700 may be enabled and executed in any order.

At block 702, the method 700 obtains a video content recording that includes one or more frames and is associated with metadata such as metadata 310 of FIG. 3. The one or more frames depict a first view (e.g., an original view) provided by a head-mounted device (HMD) at one or more instants in time. The first view includes passthrough video of a first physical environment and the passthrough video is adapted for a first viewing condition on the HMD. The metadata comprises information associated with the first viewing condition.

In some implementations, the passthrough video is adapted for the first viewing condition by adjusting a color tone of the passthrough video based on a viewing environment of the HMD having no-ambient light outside of a view of a user of the HMD.

In some implementations, the passthrough video is adapted for the first viewing condition by adjusting a color tone of the passthrough video based on a lighting condition of the viewing environment depicted in the first view.

In some implementations, the metadata identifies a lighting condition (e.g., warm, cool, etc.) of the viewing environment depicted in the first view.

In some implementations, the metadata comprises 3 by 3 matrix used to implement a color tone shift for adjusting the color of the one or more frames.

In some implementations, the metadata is used to generate a 3 by 3 matrix used to implement a color tone shift for adjusting the color of the one or more frames.

At block 704, the method 700 identifies a second viewing condition associated with a second physical environment having a second viewing condition. For example, a playback viewing condition determined from sensor data as described with respect to FIG. 3.

At block 706, the method 700 presents a second view in the second physical environment based on the video content recording. The second view is presented based on adjusting color of the one or more frames to account for the first viewing condition identified from the metadata and the second viewing condition.

In some implementations, the second view is presented via a non-immersive device in the second physical environment. For example, a color tone associated with non-immersive device 304 viewing may be adjusted to appear to user 305 to match a color tone originally experienced by user 303 of HMD 302 as described with respect to FIG. 3.

FIG. 8 is a flowchart representation of an exemplary method 800 that associates metadata (associated with a surrounding environment) with recorded image content from a multi-camera system, in accordance with some implementations. In some implementations, the method 800 is performed by a device, such as a mobile device, desktop, laptop, HMD, or server device (e.g., device 110 of FIG. 1). In some implementations, the device has a screen for displaying images and/or a screen for viewing stereoscopic images such as a head-mounted display (HMD such as e.g., device 105 of FIG. 1). In some implementations, the method 800 is performed by processing logic, including hardware, firmware, software, or a combination thereof. In some implementations, the method 800 is performed by a processor executing code stored in a non-transitory computer-readable medium (e.g., a memory). Each of the blocks in the method 800 may be enabled and executed in any order.

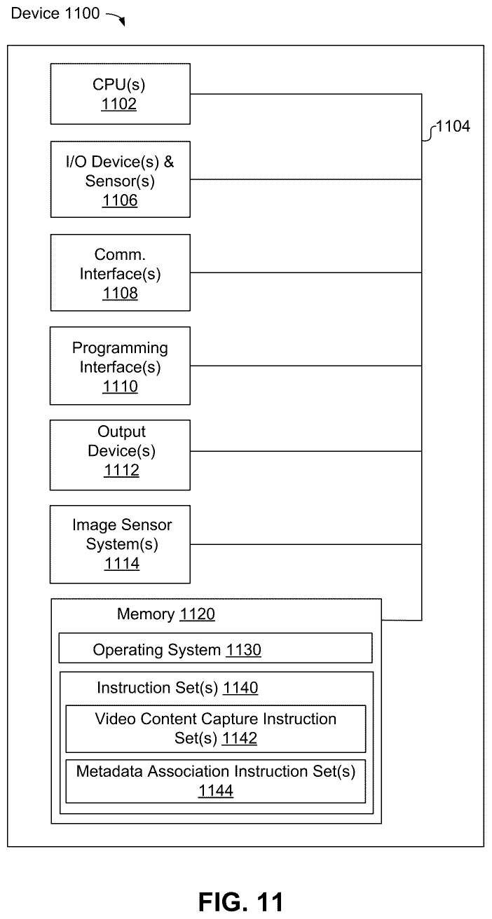

At block 802, the method 800 simultaneously captures and processes first video content corresponding to the first camera in a physical environment and second video content corresponding to the second camera in the physical environment. For example, multiple cameras facing multiple directions such as front direction 406, upward direction 417, downward direction 407, right facing direction 411, left facing direction 408, and/or rear facing direction 419 as described with respect to FIG. 430.

In some implementations, each of the first camera and the second camera may include, inter alia, a left-facing camera, a right-facing camera, side-facing camera, and a downward-facing camera, etc.

At block 804, the method 800 based on the capturing and processing of the first video content and the second video content, generates statistical information corresponding to pixel values of the first video content and the second video content. The statistical information may correspond to a total visual field of the first camera and second camera as described with respect to FIG. 4.

At block 806, the method 800 associates the statistical information as metadata with the first video content or the second video content to facilitate rendering determinations during simultaneous playback of the first video content and second video content.

In some implementations, the metadata comprises statistics specific to the first camera and the second camera.

In some implementations, the metadata may include capture parameters specific to the first camera and the second camera. The capture parameters may include, inter alia, exposure values, aperture values, white balance parameters, etc. These metadata may be dynamic and vary from frame to frame in the first video content and the second video content.

In some implementations, the metadata may include real scene-related metadata specific to the first camera and the second camera. For example, real scene-related metadata may include scene-illumination, environment ambient light, signal level for diffuse white, signal level for skin-tones, etc. These metadata may be dynamic and vary from frame to frame in the first video content and the second video content.

In some implementations, the pixel values comprise average pixel values for a total visual field of view of the first video content and the second video content.

In some implementations, the pixel values comprise minimum pixel values for a total visual field of view of the first video content and the second video content.

In some implementations, the pixel values comprise maximum pixel values for a total visual field of view of the first video content and the second video content.

In some implementations, wherein the statistical information further corresponds to an average brightness for a total visual field of view of the first video content and the second video content for HDR display.

In some implementations, the statistical information is used to enable specified rendering selections during the simultaneous playback of the first video content and the second video.

FIG. 9 is a flowchart representation of an exemplary method 900 that associates metadata (associated with a region of interest (ROI)) with recorded image content from a multi-camera system, in accordance with some implementations. In some implementations, the method 900 is performed by a device, such as a mobile device, desktop, laptop, HMD, or server device (e.g., device 110 of FIG. 1). In some implementations, the device has a screen for displaying images and/or a screen for viewing stereoscopic images such as a head-mounted display (HMD such as e.g., device 105 of FIG. 1). In some implementations, the method 900 is performed by processing logic, including hardware, firmware, software, or a combination thereof. In some implementations, the method 900 is performed by a processor executing code stored in a non-transitory computer-readable medium (e.g., a memory). Each of the blocks in the method 900 may be enabled and executed in any order.

At block 902, the method 900 simultaneously captures and processes first video content corresponding to the first camera in a physical environment and second video content corresponding to the second camera in the physical environment. For example, multiple cameras facing multiple directions such as front direction 406, upward direction 417, downward direction 407, right facing direction 411, left facing direction 408, and/or rear facing direction 419 as described with respect to FIG. 430.

In some implementations, each of the first camera and the second camera may include, inter alia, a left-facing camera, a right-facing camera, side-facing camera, and a downward-facing camera, etc.

At block 904, the method 900 based on the capturing and processing of the first video content and the second video content, generates statistical information corresponding to regions of interest in the first video content and second video content, The regions of interest may be identified based on identifying overlap in the first video content and second video content. For example, overlapping portions of a scene captured by two or more cameras as described with respect to FIG. 4.

In some implementations, the region of interest is identified based on gaze direction and the gaze direction may be used to weight image statistics associated with different portions of the first video content and the second video content.

In some implementations, the first camera and the second camera may include overlapping fields of view with respect to the first video content and the second video content and the statistical information may be configured to resolve duplicate counts due the overlapping fields.

At block 906, the method 900 associates the statistical information as metadata with the first video content or the second video content to facilitate rendering determinations during simultaneous playback of the first video content and second video content.

FIG. 10 is a flowchart representation of an exemplary method 1000 that collects left eye metadata and right eye metadata during spatial capture from left/right eye camera pipelines, in accordance with some implementations. In some implementations, the method 1000 is performed by a device, such as a mobile device, desktop, laptop, HMD, or server device (e.g., device 110 of FIG. 1). In some implementations, the device has a screen for displaying images and/or a screen for viewing stereoscopic images such as a head-mounted display (HMD such as e.g., device 105 of FIG. 1). In some implementations, the method 1000 is performed by processing logic, including hardware, firmware, software, or a combination thereof. In some implementations, the method 1000 is performed by a processor executing code stored in a non-transitory computer-readable medium (e.g., a memory). Each of the blocks in the method 1000 may be enabled and executed in any order.

At block 1002, the method 1000 simultaneously captures and processes first video content captured via the first camera in a physical environment via a first video capture pipeline and second video content captured via the second camera in the physical environment via a second video content pipeline. For example, video capture pipeline 525 and video capture pipeline 526 as illustrated in FIG. 5.

In some implementations, the first video capture pipeline comprises first camera components differing from second camera components of the second video capture pipeline.

In some implementations, the first video capture pipeline comprises first sensors differing from second sensors of the second video capture pipeline.

In some implementations, first video capture pipeline comprises first processors (e.g., ISP) differing from second processors (DSP, ZSP) of the second video capture pipeline.

In some implementations, the first video capture pipeline corresponds to a first streaming technology differing from a second streaming technology corresponding to the second video capture pipeline.

At block 1004, the method 1000 generates first information (e.g., content of a scene 502 as illustrated in FIG. 5) corresponding a first pipeline-specific characteristic of the first video capture pipeline.

At block 1006, the method 1000 generates second information (e.g., content of a scene 502 as illustrated in FIG. 5) corresponding a second pipeline-specific characteristic of the second video capture pipeline.

At block 1008, the method 1000 associates the first information and the second information as metadata with the first video content or the second video content to facilitate rendering determinations during simultaneous playback of the first video content and second video content. For example, to facilitate rendering determinations (via render modules 518 and 520) during simultaneous playback of the left eye image/video content and right eye image/video content via display 524 as described with respect to FIG. 5.

FIG. 11 is a block diagram of an example device 1100. Device 1100 illustrates an exemplary device configuration for electronic devices 105 and 110 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 1100 includes one or more processing units 1102 (e.g., microprocessors, ASICs, FPGAs, GPUs, CPUs, processing cores, and/or the like), one or more input/output (I/O) devices and sensors 1106, one or more communication interfaces 1108 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 1110, output devices (e.g., one or more displays) 1112, one or more interior and/or exterior facing image sensor systems 1114, a memory 1120, and one or more communication buses 1104 for interconnecting these and various other components.

In some implementations, the one or more communication buses 1104 include circuitry that interconnects and controls communications between system components. In some implementations, the one or more I/O devices and sensors 1106 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), one or more cameras (e.g., inward facing cameras and outward facing cameras of an HMD), one or more infrared sensors, one or more heat map sensors, and/or the like.

In some implementations, the one or more output device(s) 1112 include one or more displays configured to present a view of a 3D environment to the user. In some implementations, the one or more displays are configured to present a view of a physical environment, a graphical environment, an extended reality environment, etc. to the user. In some implementations, the one or more displays are configured to present content (determined based on a determined user/object location of the user within the physical environment) to the user. In some implementations, the one or more displays 1112 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 1100 includes a single display. In another example, the device 1100 includes a display for each eye of the user.

In some implementations, the one or more output device(s) 1112 include one or more audio producing devices. In some implementations, the one or more output device(s) 1112 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output device(s) 1112 may additionally or alternatively be configured to generate haptics.

In some implementations, the one or more image sensor systems 1114 are configured to obtain image data that corresponds to at least a portion of the physical environment 100. For example, the one or more image sensor systems 1114 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 1114 further include illumination sources that emit light, such as a flash. In various implementations, the one or more image sensor systems 1114 further include an on-camera image signal processor (ISP) configured to execute a plurality of processing operations on the image data.

In some implementations, the device 1100 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 1100 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 1100.

The memory 1120 includes high-speed random-access memory, such as DRAM, SRAM, DDR RAM, or other random-access solid-state memory devices. In some implementations, the memory 1120 includes non-volatile memory, such as one or more magnetic disk storage devices, optical disk storage devices, flash memory devices, or other non-volatile solid-state storage devices. The memory 1120 optionally includes one or more storage devices remotely located from the one or more processing units 1102. The memory 1120 includes a non-transitory computer readable storage medium.

In some implementations, the memory 1120 or the non-transitory computer readable storage medium of the memory 1120 stores an optional operating system 1130 and one or more instruction set(s) 1140. The operating system 1130 includes procedures for handling various basic system services and for performing hardware dependent tasks. In some implementations, the instruction set(s) 1140 include executable software defined by binary information stored in the form of electrical charge. In some implementations, the instruction set(s) 1140 are software that is executable by the one or more processing units 1102 to carry out one or more of the techniques described herein.

The instruction set(s) 1140 includes a video content capture instruction set 1142 and a metadata association instruction set 1144. The instruction set(s) 1140 may be embodied as a single software executable or multiple software executables.

The video content capture instruction set 1142 is configured with instructions executable by a processor to capture video content for rendering via one or more displays.

The metadata association instruction set 1144 is configured with instructions executable by a processor to incorporate enhanced metadata into spatial and/or mixed reality capture environments to control rendering attributes of video content with respect to differing displays.

Although the instruction set(s) 1140 are shown as residing on a single device, it should be understood that in other implementations, any combination of the elements may be located in separate computing devices. Moreover, FIG. 11 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a head-mounted device (HMD) having a processor:
capturing an original video content recording, the original video content recording comprising one or more frames depicting a first view provided by the HMD at one or more instants in time;
generating an adapted video content recording by adapting brightness of the one or more frames of the original video content recording to account for a difference between a first viewing condition associated with the first view and a second viewing condition associated with non-immersive viewing;
generating metadata comprising information associated with the first viewing condition; and
associating the metadata with the adapted video content recording.

2. The method of claim 1, further comprising:
enabling playback operations on a non-immersive device using the adapted video content recording.

3. The method of claim 2, wherein the playback operations provide a consistent user viewing experience in accordance with a brightness level associated with the first view.

4. The method of claim 1, further comprising
enabling playback operations on the HMD by further adapting the adapted video content using the metadata.

5. The method of claim 4, wherein the playback operations provide a consistent user viewing experience with respect to a brightness level associated with the first view.

6. The method of claim 1, wherein the first viewing condition comprises a dim lighting viewing condition provided by the HMD with a minimal amount of ambient lighting.

7. The method of claim 1, wherein the first viewing condition comprises a dim lighting viewing condition provided by the HMD with no ambient lighting.

8. The method of claim 1, wherein the second viewing condition comprises a bright lighting viewing condition viewed in a physical environment with ambient lighting.

9. The method of claim 1, wherein the information associated with the first viewing condition comprises a brightness adaptation measurement configured to determine a light intensity associated with eyes of a user with respect to viewing conditions of the HMD during said capturing.

10. The method of claim 1, wherein said associating the metadata with the adapted video content recording comprises storing the metadata with the adapted video content recording in a same file.

11. The method of claim 1, wherein said associating the metadata with the adapted video content recording comprises storing the metadata with the adapted video content recording with respect to a same streaming format.

12. A head-mounted device (HMD) comprising:
a non-transitory computer-readable storage medium; and
one or more processors coupled to the non-transitory computer-readable storage medium, wherein the non-transitory computer-readable storage medium comprises program instructions that, when executed on the one or more processors, cause the electronic device to perform operations comprising:
capturing an original video content recording, the original video content recording comprising one or more frames depicting a first view provided by the HMD at one or more instants in time;
generating an adapted video content recording by adapting brightness of the one or more frames of the original video content recording to account for a difference between a first viewing condition associated with the first view and a second viewing condition associated with non-immersive viewing;
generating metadata comprising information associated with the first viewing condition; and
associating the metadata with the adapted video content recording.

13. The HMD of claim 12, wherein the program instructions, when executed on the one or more processors, further cause the HMD to perform operations comprising:
enabling playback operations on a non-immersive device using the adapted video content recording.

14. The HMD of claim 13, wherein the playback operations provide a consistent user viewing experience in accordance with a brightness level associated with the first view.

15. The HMD of claim 12, wherein the program instructions, when executed on the one or more processors, further cause the HMD to perform operations comprising:
enabling playback operations on the HMD by further adapting the adapted video content using the metadata.

16. The HMD of claim 15, wherein the playback operations provide a consistent user viewing experience with respect to a brightness level associated with the first view.

17. The HMD of claim 12, wherein the first viewing condition comprises a dim lighting viewing condition provided by the HMD with a minimal amount of ambient lighting.

18. The HMD of claim 12, wherein the first viewing condition comprises a dim lighting viewing condition provided by the HMD with no ambient lighting.

19. The HMD of claim 12, wherein the second viewing condition comprises a bright lighting viewing condition viewed in a physical environment with ambient lighting.

20. A non-transitory computer-readable storage medium storing program instructions executable via one or more processors, of a head-mounted device (HMD), to perform operations comprising:
capturing an original video content recording, the original video content recording comprising one or more frames depicting a first view provided by the HMD at one or more instants in time;
generating an adapted video content recording by adapting brightness of the one or more frames of the original video content recording to account for a difference between a first viewing condition associated with the first view and a second viewing condition associated with non-immersive viewing;
generating metadata comprising information associated with the first viewing condition; and
associating the metadata with the adapted video content recording.
